(19) United States
(12) Patent Application Publication
(10) Pub. No.: US 2026/0196905 A1
(43) Pub. Date: Jul. 9, 2026

(54) INTEGRATED SWITCHING DEVICE AND MOTOR CONTROL SYSTEM

(71) Applicant: DEFOND ELECTECH CO., LTD., Dongguan City (CN)

(72) Inventors: Cheng Chen NIEH, Dongguan City (CN); Kin Yu WONG, Dongguan City (CN); Lap Yi LAW, Dongguan City (CN); Bin LI, Dongguan City (CN)

(21) Appl. No.: 19/201,143

(22) Filed: May 7, 2025

(30) Foreign Application Priority Data
Jan. 7, 2025 (CN) 2025200386104

(51) Int. Cl. H02K 11/28; H02K 7/14

(52) U.S. Cl. CPC H02K 11/28; H02K 7/145; H02K 2211/03

(57) ABSTRACT

Provided are an integrated switching device and a motor control system. The integrated switching device includes main body housing, button mechanism, steering rod mechanism, and circuit board mechanism, wherein the button mechanism and the steering rod mechanism are matched and mounted on the main body housing, and a first rotation space and a second rotation space are arranged on a side surface of the button mechanism; the steering rod mechanism is provided with a locking plug, and the locking plug is unlocked by toggling the steering rod mechanism and is oriented towards the first rotation space or the second rotation space, so as to select a driven direction of an electric motor and to release safety locking, so that the button mechanism is able to slide downwardly; and the circuit board mechanism is mounted on the main body housing, and the button mechanism is matched to the circuit board mechanism.

### CROSS-REFERENCE TO RELATED APPLICATION

The present disclosure claims priority to Chinese patent application No. 2025200386104, filed with the Chinese Patent Office on Jan. 7, 2025, the entire contents of which are incorporated herein by reference.

### TECHNICAL FIELD

The present disclosure relates to the technical field of switching control, and specifically to an integrated switching device and a motor control system.

### BACKGROUND ART

Generally, as for the electric motor-driven device or the handheld electric tool, such as the electric motor-driven screwdriver, mixer, stirrer, and hand drill, most of the switching buttons and motor control modules are arranged separately, and the assembly operation is relatively complicated. It has problems of inconvenient mounting and low mounting efficiency, and the experience of users is poorer.

### SUMMARY

The objective of the present disclosure is to provide an integrated switching device and a motor control system, which can realize technical effects of simplifying the assembly operation and improving the mounting efficiency and the experience of users.

The present disclosure provides an integrated switching device, including a main body housing, a button mechanism, a steering rod mechanism, and a circuit board mechanism.

The button mechanism and the steering rod mechanism are matched and mounted on the main body housing, and a first rotation space and a second rotation space are arranged on a side surface of the button mechanism; the steering rod mechanism is provided with a locking plug, and the locking plug is unlocked by toggling the steering rod mechanism and is oriented towards the first rotation space or the second rotation space, so as to select a driven direction of an electric motor and to release safety locking, so that the button mechanism can slide downwardly.

The circuit board mechanism is mounted on the main body housing, and the button mechanism is matched to the circuit board mechanism.

In the above realization process, the button mechanism and the steering rod mechanism are matched and mounted in the main body housing in the integrated switching device. By toggling the steering rod mechanism to different directions, the rotation direction of the corresponding motor can be controlled; and by pressing the button mechanism, the start, stop, and rotation speed of the corresponding motor can be controlled. Therefore, in the integrated switching device, the button switch and the motor control module, which are previously separated, are integrated into the button mechanism and the steering rod mechanism, and the button mechanism and the steering rod mechanism are integrally mounted in the main body housing. The assembly operation is simple and convenient, which facilitates the mounting and reduces the mounting duration. This can realize the technical effects of simplifying the assembly operation and improving the mounting efficiency and the experience of users.

Further, the main body housing includes a face housing and a bottom housing, wherein the face housing is provided with a button mounting groove and a steering rod mounting groove; the button mechanism is matched and mounted to the button mounting groove; the steering rod mechanism is matched and mounted to the steering rod mounting groove; the circuit board mechanism is mounted to the bottom housing; and the face housing and the bottom housing are mounted in a sealing method.

In the above realization process, the button mounting groove and steering rod mounting groove are arranged on the face housing, and the button mechanism and the steering rod mechanism are integrally mounted, which provides a simple and convenient assembly. Additionally, the face housing and the bottom housing are mounted in the sealing method, wherein the button mechanism and the steering rod mechanism are sealed in an interior space formed by the face housing and the bottom housing, which avoids erosion and interference from the external environment, and realizes effects of dust-proofing and rust-proofing.

Further, the face housing is provided with a fusion line, and the bottom housing is provided with a fusion groove, wherein the fusion line is matched to the fusion groove, and the fusion line and the fusion groove are sealed by ultrasonic waves when the face housing is matched and mounted to the bottom housing.

In the above realization process, after the assembly of the face housing and the bottom housing, the fusion line on the face housing and the fusion groove on the bottom housing are fused and bonded by utilizing high-frequency vibrations of the ultrasonic waves, which improves the sealing effect between the face housing and the bottom housing.

Further, the steering rod mechanism includes a steering rod body and a first sliding sheet, and the first sliding sheet is matched to the steering rod body.

In the above realization process, the first sliding sheet slides to the corresponding conductive track by toggling the steering rod body, so as to adjust the rotation direction of the preset motor, wherein the conductive track corresponding to the first sliding sheet is arranged on the circuit board mechanism.

Further, the button mechanism includes a button body, a second sliding sheet, and an elastic member, wherein the elastic member is mounted inside the button body, and the second sliding sheet is matched and mounted on a side surface of the button body.

In the above realization process, the second sliding sheet arranged on the button mechanism is in contact with the corresponding conductive track by pressing the button mechanism, wherein conductive resistances at different positions are different, so as to adjust the rotation speed of the preset motor, and the elastic member is configured to provide elastic power to the button body. The conductive track corresponding to the second sliding sheet is arranged on circuit board mechanism.

Further, the circuit board mechanism includes a circuit board body; and an input electric wire, a capacitor, and an output electric wire that are mounted on the circuit board body, wherein an output end of the input electric wire, the capacitor, and an input end of the output electric wire are connected in sequence; an input end of the input electric wire is connected to a power supply source; and an output end of the output electric wire is connected to a preset motor.

Further, the circuit board mechanism further includes a motor circuit board, wherein the motor circuit board is matched to the preset motor.

In the above realization process, the motor circuit board is matched and mounted to the preset motor, and the preset motor is electrically connected to the circuit board body and the output electric wire by the motor circuit board.

Further, the integrated switching device further includes a terminal fixing base, wherein the terminal fixing base is matched and mounted to the button mechanism and the main body housing respectively.

In the above realization, the terminals in the integrated switching device are fixed by the terminal fixing base.

Further, the first rotation space and the second rotation space are guide slots; the locking plug is a protruding guide member; and the protruding guide member can slide in the guide slots.

In a second aspect, the present disclosure provides a motor control system, including the integrated switching device as described in any one of the first aspect.

Other features and advantages of the present disclosure will be described in the subsequent specification, or, partial features and advantages can be deduced or determined from the specification without doubt or can be known by performing techniques of the present disclosure as described above.

In order to make the above purposes, features, and advantages of the present disclosure more obvious and easier to understand, the following is a detailed description of preferred embodiments in conjunction with the drawings.

### BRIEF DESCRIPTION OF DRAWINGS

In order to more clearly illustrate the technical solutions in the embodiments of the present disclosure, the drawings to be used in the embodiments of the present disclosure will be briefly introduced below. It should be understood that the following drawings only show certain embodiments of the present disclosure. Therefore, they should not be regarded as a limitation of the scope. For a person of ordinary skill in the art, other relevant drawings can be obtained according to these drawings without inventive efforts.

FIG. 1 shows a structure schematic diagram of an integrated switching device at a first view provided by the embodiments of the present disclosure;

FIG. 2 shows a structure schematic diagram of an integrated switching device at a second view provided by the embodiments of the present disclosure;

FIG. 3 shows a structure schematic diagram of an integrated switching device at a third view provided by the embodiments of the present disclosure;

FIG. 4 shows a schematic diagram of a first explosion structure of an integrated switching device provided by the embodiments of the present disclosure;

FIG. 5 shows a schematic diagram of a second explosion structure of an integrated switching device provided by the embodiments of the present disclosure;

FIG. 6 shows a structure schematic diagram of a circuit board body and a capacitor provided by the embodiments of the present disclosure;

FIG. 7 shows a schematic diagram of a partial sectional structure of an integrated switching device provided by the embodiments of the present disclosure;

FIG. 8 shows a schematic diagram of a partial sectional structure of an integrated switching device under a pressure of an elastic member provided by the embodiments of the present disclosure; and

FIG. 9 shows a schematic diagram of a partial sectional structure of an integrated switching device when an elastic member is released provided by the embodiments of the present disclosure.

Reference numbers: main body housing 100; face housing 110; button mounting groove 111; steering rod mounting groove 112; bottom housing 120; button mechanism 200; first rotation space 210; second rotation space 220; button body 230; second sliding sheet 240; elastic member 250; steering rod mechanism 300; locking plug 310; steering rod body 320; first sliding sheet 330; circuit board mechanism 400; circuit board body 410; input electric wire 420; capacitor 430; output electric wire 440; motor circuit board 450; and terminal fixing base 500.

### DETAILED DESCRIPTION OF EMBODIMENTS

The technical solutions in the embodiments of the present disclosure will be clearly and completely described below in conjunction with the drawings in the embodiments of the present disclosure. It is clear that the embodiments described are only partial embodiments of the present disclosure, and not all of the embodiments. The assembly in embodiments of the present disclosure generally described and shown in the drawings herein can be arranged and designed in various different configurations. Therefore, the following detailed description of the embodiments of the present disclosure arranged in the drawings is not intended to limit the scope of the present disclosure for which protection is claimed, but only represents selected embodiments of the present disclosure. Based on the embodiments in the present disclosure, all other embodiments, obtained by a person skilled in the art without inventive efforts, shall all fall within the scope of protection of the present disclosure.

In the present disclosure, orientations or positional relationships indicated by the terms “up”, “down”, “left”, “right”, “front”, “back”, “top”, “bottom”, “inside”, “outside”, “center”, “vertical”, “horizontal”, “transverse”, “longitudinal”, etc., are the orientations or positional relationships based on showing in the drawings. These terms are used primarily to better describe the present disclosure and the embodiments, and are not intended to limit that the indicated device, component, or composition must have a particular orientation, or be constructed and operated in a particular orientation.

Moreover, some of the above terms can be used to indicate other meanings in addition to the orientations or positional relationships. For example, the term “on” may also be used to indicate a certain dependency relationship or a connection relationship in some cases. For a person of ordinary skill in the art, the specific meaning of these terms in the present disclosure can be understood according to specific situations.

Additionally, the terms “mount”, “arrange”, “provide”, “connect”, and “link” are to be understood in a broad sense. For example, it can be a fixed connection, a detachable connection, or an integral construction; it can be a mechanical connection or a point connection; and it can be a direct connection, an indirect connection through an intermediate medium, or a communication inside two devices, components, and compositions. For a person of ordinary skill in the art, the specific meaning of the above terms in the present disclosure can be understood according to specific situations.

Additionally, the terms “first”, “second”, etc. are used primarily to distinguish between different devices, components, or compositions (wherein the specific types and constructions can be the same or different), and they are not intended to indicate or imply the relative importance and the amounts of the indicated devices, components, or compositions. Unless otherwise indicated, “plurality” means two or more.

The embodiments of the present disclosure provide an integrated switching device and a motor control system, which can be applied to the motor control process of power tools. The button mechanism and the steering rod mechanism are matched and mounted in the main body housing in the integrated switching device. By toggling the steering rod mechanism to rotate to different directions, the rotation direction of the corresponding motor can be controlled; and the start, stop, and rotation speed of the corresponding motor can be controlled by pressing the button mechanism. Therefore, in the integrated switching device, the previously separate button switch and the motor control module are integrated into the button mechanism and the steering rod mechanism, and the button mechanism and the steering rod mechanism are integrally mounted in the main body housing. The assembly operation is simple and convenient, which facilitates the mounting and reduces the mounting duration, and can realize the technical effects of simplifying the assembly operation and improving the mounting efficiency and the experience of users.

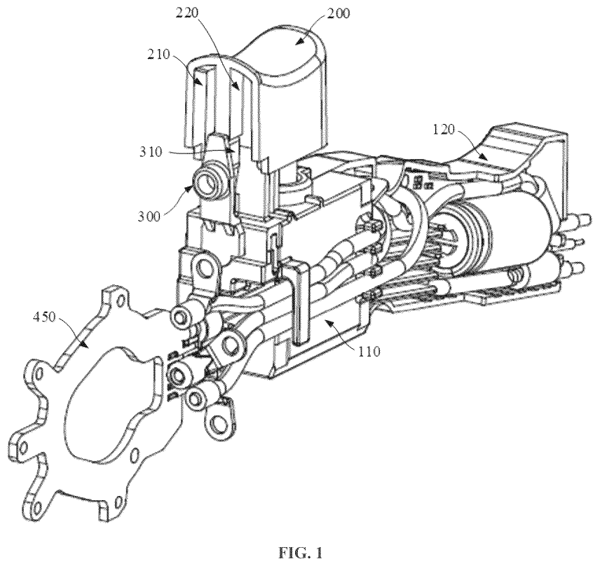

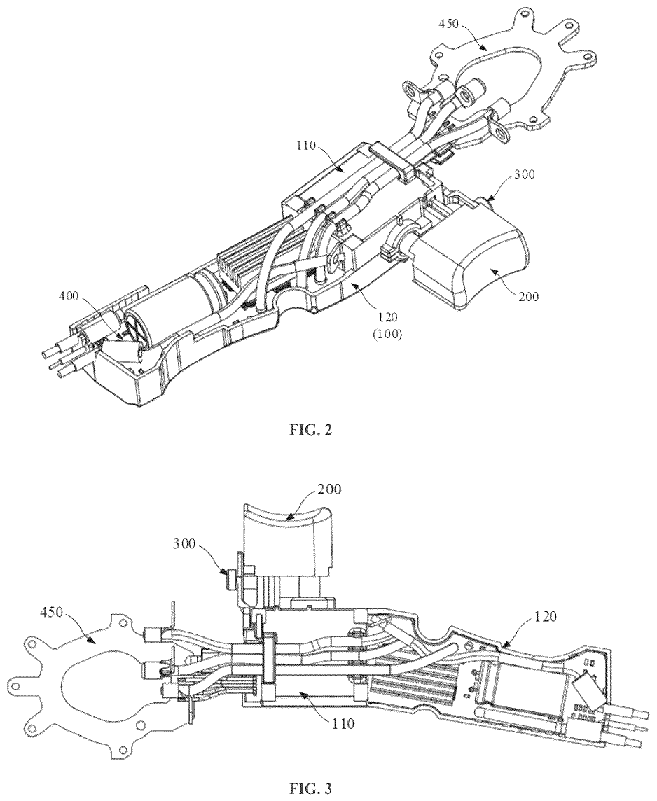

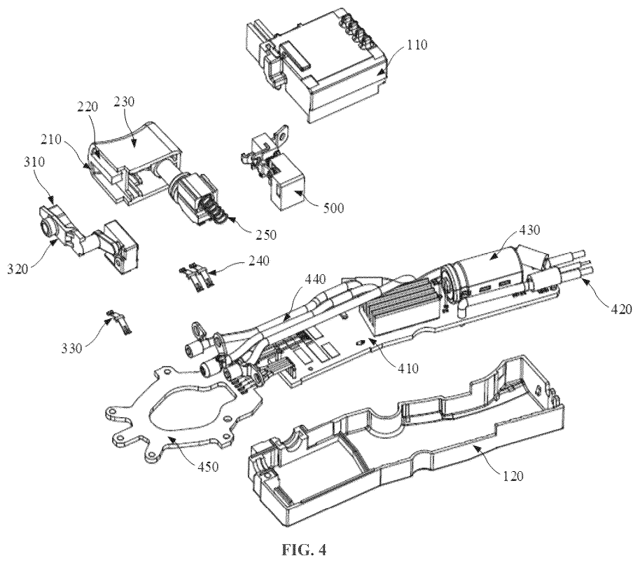

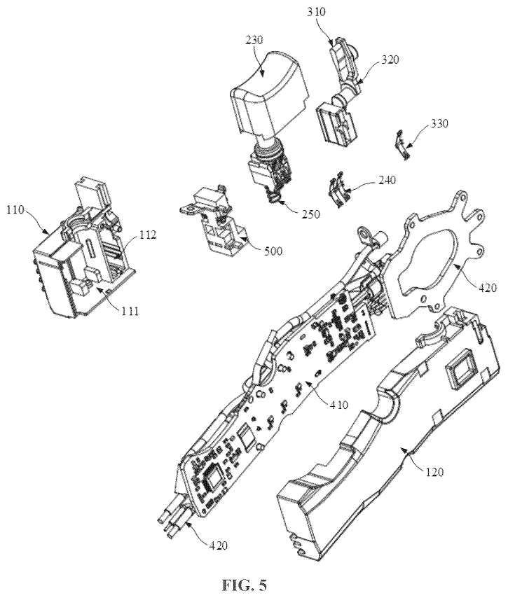

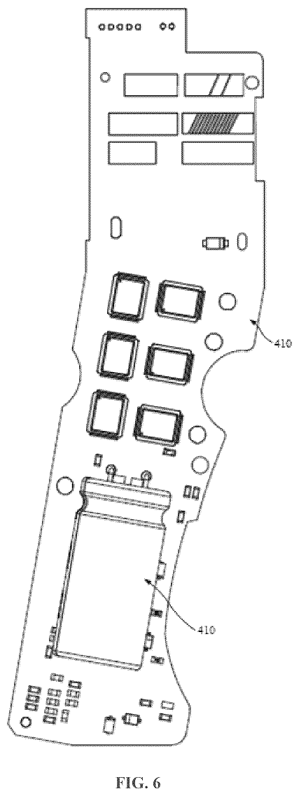

Referring to FIG. 1 to FIG. 6, FIG. 1 shows a structure schematic diagram of the integrated switching device at a first view provided by the embodiments of the present disclosure; FIG. 2 shows a structure schematic diagram of the integrated switching device at a second view provided by the embodiments of the present disclosure; FIG. 3 shows a structure schematic diagram of the integrated switching device at a third view provided by the embodiments of the present disclosure; FIG. 4 shows a schematic diagram of a first explosion structure of the integrated switching device provided by the embodiments of the present disclosure; FIG. 5 shows a schematic diagram of a second explosion structure of the integrated switching device provided by the embodiments of the present disclosure; and FIG. 6 shows a structure schematic diagram of a circuit board body and a capacitor provided by the embodiments of the present disclosure. The integrated switching device includes a main body housing 100, a button mechanism 200, a steering rod mechanism 300, and a circuit board mechanism 400.

Exemplarily, the button mechanism 200 and the steering rod mechanism 300 are matched and mounted on the main body housing 100, and a first rotation space 210 and a second rotation space 220 are arranged on a side surface of the button mechanism 200; the steering rod mechanism 300 is provided with a locking plug 310, and the locking plug 310 is unlocked by toggling the steering rod mechanism 300 and is oriented towards the first rotation space 210 or the second rotation space 220, so as to select a driven direction of the electric motor and to release safety locking, so that the button mechanism 200 can slide downwardly.

The integrated switching device is configured to control the preset motor. By toggling the steering rod mechanism 300, the sliding sheet (metal brush sheet) arranged on the steering rod mechanism 300 can slide to the corresponding conductive track, so as to adjust the rotation direction of the preset motor. By pressing the button, the sliding sheet (metal brush sheet) arranged on the button mechanism 200 is in contact with the corresponding conductive track, wherein conductive resistances at different positions are different, so as to adjust the rotation speed of the preset motor.

Optionally, the conductive tracks are arranged on the circuit board mechanism 400, wherein at least two conductive tracks on the circuit board mechanism 400 are provided, and they correspond to the button mechanism 200 and the steering rod mechanism 300 respectively.

Optionally, the button mechanism 200 is matched to the steering rod mechanism 30, wherein the first rotation space 210 and the second rotation space 220 on the button mechanism 200 can be arranged as two parallel grooves; the locking plug 310 on the steering rod mechanism 300 can be a protrusion structure; and the protrusion structure can slide along the grooves.

In some embodiments, the first rotation space 210 and the second rotation space 220 on the button mechanism 200 can be arranged as two parallel protrusion structures. The locking plug 310 on the steering rod mechanism 300 can be a groove, and the groove can slide along the protrusion structure.

Exemplarily, the circuit board mechanism 400 is mounted on the main body housing, and the button mechanism is matched to the circuit board mechanism.

Exemplarily, the button mechanism 200 and the steering rod mechanism 300 are matched and mounted in the main body housing 100 in the integrated switching device, wherein the rotation direction of the corresponding motor can be controlled by toggling the steering rod mechanism 300 to different directions; and the start, stop, and rotation speed of the corresponding motor can be controlled by pressing the button mechanism 200. Therefore, in the integrated switching device, the button switch and the motor control module which are previously separated are integrated into the button mechanism and the steering rod mechanism, and the button mechanism 200 and the steering rod mechanism 300 are integrally mounted in the main body housing 100. The assembly operation is simple and convenient, which facilitates the mounting, reduces the mounting duration, and realizes the technical effects of simplifying the assembly operation and improving the mounting efficiency and the experience of users.

Exemplarily, the main body housing 100 includes a face housing 110 and a bottom housing 120, wherein the face housing 110 is provided with a button mounting groove 111 and a steering rod mounting groove 112; the button mechanism 200 is matched and mounted to the button mounting groove 111; the steering rod mechanism 300 is matched and mounted to the steering rod mounting groove 112; the circuit board mechanism 400 is mounted to the bottom housing 120; and the face housing 110 and the bottom housing 120 are mounted in a sealing method.

Exemplarily, the button mounting groove 111 and steering rod mounting groove 112 are arranged on the face housing. The button mechanism 200 and the steering rod mechanism 300 are integrally mounted, which provides a simple and convenient assembly. Additionally, the face housing 110 and the bottom housing 120 are mounted in the sealing method, wherein the button mechanism 200 and the steering rod mechanism 300 are sealed in an interior space formed by the face housing 110 and the bottom housing 120, which avoids erosion and interference from the external environment, and realizes effects of dust-proofing and rust-proofing.

Exemplarily, the face housing 110 is provided with a fusion line, and the bottom housing 120 is provided with a fusion groove, wherein the fusion line is matched to the fusion groove, and the fusion line and the fusion groove are sealed by ultrasonic waves when the face housing 110 is matched and mounted to the bottom housing 120.

Exemplarily, after the assembly of the face housing 110 and the bottom housing 120, the fusion line on the face housing 110 and the fusion groove on the bottom housing 120 are fused and bonded by utilizing high-frequency vibrations of the ultrasonic waves, which improves the sealing effect between the face housing 110 and the bottom housing 120.

In some embodiments, the face housing 110 and the bottom housing 120 are made of plastic.

Exemplarily, the steering rod mechanism 300 includes a steering rod body 320 and a first sliding sheet 330, and the first sliding sheet 330 is matched to the steering rod body 320.

Exemplarily, the first sliding sheet 330 slides to the corresponding conductive track by toggling the steering rod body 320, so as to adjust the rotation direction of the preset motor. The conductive track corresponding to the first sliding sheet 330 is arranged on the circuit board mechanism 400.

Exemplarily, the button mechanism 200 includes a button body 230, a second sliding sheet 240, and an elastic member 250, wherein the elastic member 250 is mounted inside the button body 230, and the second sliding sheet 240 is matched and mounted on the side surface of the button body 230.

Exemplarily, the second sliding sheet 240 arranged on the button mechanism 200 is in contact with the corresponding conductive track by pressing the button mechanism 200, wherein conductive resistances at different positions are different, so as to adjust the rotation speed of the preset motor. The elastic member 250 is configured to provide elastic power to the button body 230, wherein the conductive track corresponding to the second sliding sheet 240 is arranged on circuit board mechanism 400.

In some embodiments, a plurality of second sliding sheets 240 can be provided.

Optionally, the elastic member 250 is a tension spring.

Exemplarily, the circuit board mechanism 400 includes a circuit board body 410; and an input electric wire 420, a capacitor 430, and an output electric wire 440 that are mounted on the circuit board body 410, wherein an output end of the input electric wire 420, the capacitor 430, and an input end of the output electric wire 440 are connected in sequence. An input end of the input electric wire 420 is connected to a power supply source, and an output end of the output electric wire 440 is connected to the preset motor.

Exemplarily, the circuit board mechanism 400 further includes a motor circuit board 450, wherein the motor circuit board 450 is matched to the preset motor.

Exemplarily, the motor circuit board 450 is matched and mounted to the preset motor, and the preset motor is electrically connected to the circuit board body 410 and the output electric wire 440 by the motor circuit board 450.

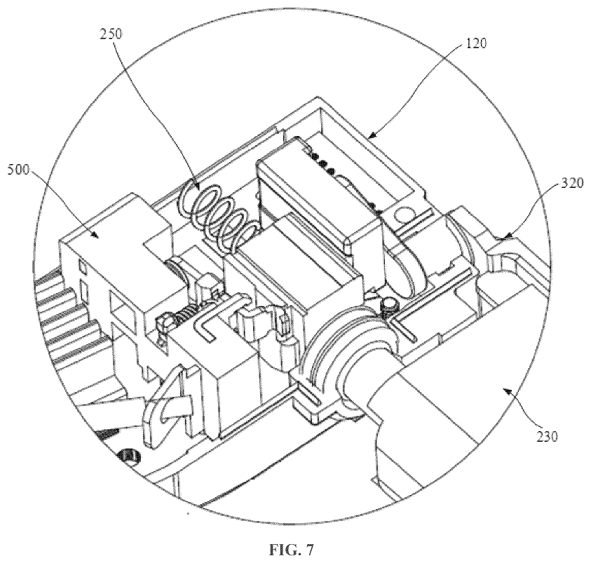

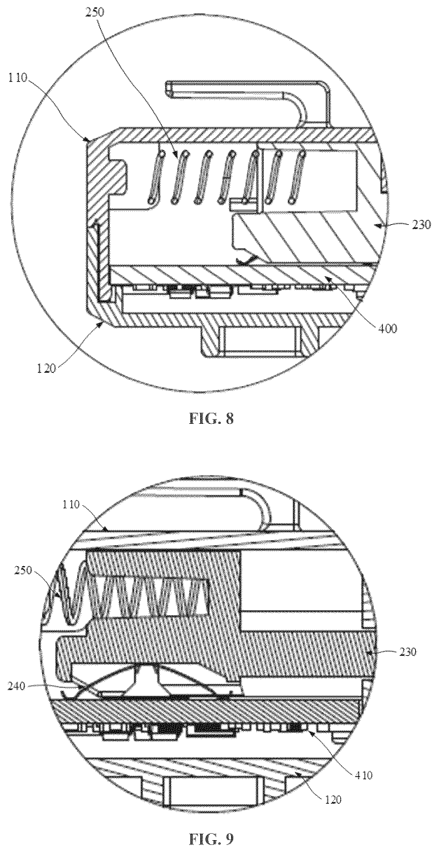

Referring to FIG. 7 to FIG. 9, FIG. 7 shows a schematic diagram of a partial section structure of an integrated switching device provided by the embodiments of the present disclosure; FIG. 8 shows a schematic diagram of a partial sectional structure of an integrated switching device under a pressure of an elastic member provided by the embodiments of the present disclosure; and FIG. 9 shows a schematic diagram of a partial sectional structure of an integrated switching device when an elastic member is released provided by the embodiments of the present disclosure.

Exemplarily, the integrated switching device further includes a terminal fixing base 500, wherein the terminal fixing base 500 is matched and mounted to the button mechanism 200 and the main body housing 100 respectively.

Exemplarily, the terminals in the integrated switching device are fixed by the terminal fixing base 500.

Optionally, the terminals in the integrated switching device include a fixed terminal electrically connected to the circuit board mechanism 400 and a movable contact terminal. When the button mechanism 200 is pressed, the pressure against the elastic member 250 (tension spring) disappears. The contact terminal is pulled toward the fixed terminal by the elastic member 250, so that the contact terminal and the fixed terminal are connected, which realizes switching of the integrated switching device.

Exemplarily, the first rotation space 210 and the second rotation space 220 are guide slots. The locking plug 310 is a protruding guide member, and the protruding guide member can slide in the guide slots.

In a second aspect, the present disclosure provides a motor control system, including the integrated switching device in any one of the first aspects.

In all embodiments of the present disclosure, “large” and “small” are relative, “more” and “less” are relative, “up” and “down” are relative, and the expression of such relative terms is not repeated in the embodiment of the present disclosure.

It should be understood that the words “in the embodiment”, “in the embodiment of the present disclosure” or “as an optional embodiment” mentioned throughout the specification mean that a particular feature, structure, or characteristic relative to the embodiment is included in at least one embodiment of the present disclosure. Therefore, the words “in the embodiment”, “in the embodiment of the present disclosure”, or “as an optional embodiment” appearing throughout the specification may not necessarily refer to the same embodiment. Additionally, these particular features, structures, or characteristics may be combined in one or two embodiments in any suitable method. It should also be appreciated by those skilled in the art that the embodiments described in the specification are all optional embodiments, and the actions and modules involved are not necessarily necessary for the present disclosure.

In the various embodiments of the present disclosure, it should be understood that the magnitude of the sequence number of the processes above does not imply an inevitable sequence of execution. The sequence of execution of each process shall be determined by its function and internal logic, and shall not constitute any limitation on the implementation process of the embodiments of the present disclosure.

The above is only the specific embodiment of the present disclosure, and the scope of protection of the present disclosure is not limited to this. Any change or replacement that can be easily thought of by any technical person familiar with the technical field within the technical scope disclosed by the present disclosure shall be covered within the protection scope of the present disclosure. Therefore, the scope of protection of the present disclosure shall be subject to the scope of protection of the claims.

1. An integrated switching device, comprising a main body housing, a button mechanism, a steering rod mechanism, and a circuit board mechanism, wherein
the button mechanism and the steering rod mechanism are matched and mounted on the main body housing, and a first rotation space and a second rotation space are arranged on a side surface of the button mechanism; the steering rod mechanism is provided with a locking plug, and the locking plug is unlocked by toggling the steering rod mechanism and is oriented towards the first rotation space or the second rotation space, so as to select a driven direction of an electric motor and to release safety locking, so that the button mechanism is able to slide downwardly; and
the circuit board mechanism is mounted on the main body housing, and the button mechanism is matched to the circuit board mechanism.

2. The integrated switching device according to claim 1, wherein the main body housing comprises a face housing and a bottom housing; the face housing is provided with a button mounting groove and a steering rod mounting groove; the button mechanism is matched and mounted to the button mounting groove; the steering rod mechanism is matched and mounted to the steering rod mounting groove; the circuit board mechanism is mounted to the bottom housing; and the face housing and the bottom housing are mounted in a sealing method.

3. The integrated switching device according to claim 2, wherein the face housing is provided with a fusion line, and the bottom housing is provided with a fusion groove, the fusion line is matched to the fusion groove, and the fusion line and the fusion groove are sealed by ultrasonic waves when the face housing is matched and mounted to the bottom housing.

4. The integrated switching device according to claim 2, wherein the steering rod mechanism comprises a steering rod body and a first sliding sheet, and the first sliding sheet is matched to the steering rod body.

5. The integrated switching device according to claim 1, wherein the button mechanism comprises a button body, a second sliding sheet, and an elastic member, the elastic member is mounted inside the button body, and the second sliding sheet is matched and mounted on a side surface of the button body.

6. The integrated switching device according to claim 1, wherein the circuit board mechanism comprises a circuit board body; and an input electric wire, a capacitor, and an output electric wire that are mounted on the circuit board body, wherein an output end of the input electric wire, the capacitor, and an input end of the output electric wire are connected in sequence; an input end of the input electric wire is connected to a power supply source; and an output end of the output electric wire is connected to a preset motor.

7. The integrated switching device according to claim 6, wherein the circuit board mechanism further comprises a motor circuit board, and the motor circuit board is matched to the preset motor.

8. The integrated switching device according to claim 7, wherein the integrated switching device further comprises a terminal fixing base, and the terminal fixing base is matched and mounted to the button mechanism and the main body housing respectively.

9. The integrated switching device according to claim 1, wherein the first rotation space and the second rotation space are guide slots; the locking plug is a protruding guide member; and the protruding guide member is able to slide in the guide slots.

10. A motor control system, comprising the integrated switching device according to claim 1.

11. The integrated switching device according to claim 4, wherein the button mechanism comprises a button body, a second sliding sheet, and an elastic member, the elastic member is mounted inside the button body, and the second sliding sheet is matched and mounted on a side surface of the button body.

12. The motor control system according to claim 10, wherein the main body housing comprises a face housing and a bottom housing; the face housing is provided with a button mounting groove and a steering rod mounting groove; the button mechanism is matched and mounted to the button mounting groove; the steering rod mechanism is matched and mounted to the steering rod mounting groove; the circuit board mechanism is mounted to the bottom housing; and the face housing and the bottom housing are mounted in a sealing method.

13. The motor control system according to claim 12, wherein the face housing is provided with a fusion line, and the bottom housing is provided with a fusion groove, the fusion line is matched to the fusion groove, and the fusion line and the fusion groove are sealed by ultrasonic waves when the face housing is matched and mounted to the bottom housing.

14. The motor control system according to claim 12, wherein the steering rod mechanism comprises a steering rod body and a first sliding sheet, and the first sliding sheet is matched to the steering rod body.

15. The motor control system according to claim 10, wherein the button mechanism comprises a button body, a second sliding sheet, and an elastic member, the elastic member is mounted inside the button body, and the second sliding sheet is matched and mounted on a side surface of the button body.

16. The motor control system according to claim 10, wherein the circuit board mechanism comprises a circuit board body; and an input electric wire, a capacitor, and an output electric wire that are mounted on the circuit board body, wherein an output end of the input electric wire, the capacitor, and an input end of the output electric wire are connected in sequence; an input end of the input electric wire is connected to a power supply source; and an output end of the output electric wire is connected to a preset motor.

17. The motor control system according to claim 16, wherein the circuit board mechanism further comprises a motor circuit board, and the motor circuit board is matched to the preset motor.

18. The motor control system according to claim 17, wherein the integrated switching device further comprises a terminal fixing base, and the terminal fixing base is matched and mounted to the button mechanism and the main body housing respectively.

19. The motor control system according to claim 10, wherein the first rotation space and the second rotation space are guide slots; the locking plug is a protruding guide member; and the protruding guide member is able to slide in the guide slots.
